(19) United States
(12) Patent Application Publication
(10) Pub. No.: US 2026/0265090 A1
(43) Pub. Date: Sep. 10, 2026

(54) Fresh Water Production at the Point of Need Using an Integrated System of Capacitive Deionization and Electrochemical Disinfection

(71) Applicant: Global Graphene Group, Inc., Dayton, OH (US)

(72) Inventors: Hammad Younes, Dayton, OH (US); Bor Z. Jang, Centerville, OH (US)

(73) Assignee: Global Graphene Group, Inc., Dayton, OH (US)

(21) Appl. No.: 19/071,655

(22) Filed: Mar. 5, 2025

(51) Int. Cl. C02F 1/469; B01D 61/42; C01B 32/184; C01B 32/198; C01B 32/921; C02F 1/461; C02F 1/467; C02F 101/36; C02F 103/08

(52) U.S. Cl. CPC C02F 1/4691; B01D 61/4281; C01B 32/184; C01B 32/198; C01B 32/921; C02F 1/46109; C02F 1/467; B01D 2313/345; C01P 2006/40; C02F 2001/46119; C02F 2001/46142; C02F 2101/36; C02F 2103/08; C02F 2301/08; C02F 2303/04; C02F 2305/08

(57) ABSTRACT

A method of producing clean water from contaminated or saline water, the method comprising integrating at least a capacitive deionization (CDI) unit and at least an electrochemical or electro-catalytic disinfection (ECD) unit to create a water purification system, wherein at least one of the CDI and ECD units comprises an electrode comprising graphene, MXene, a redox-active or Faradaic functional group, a PFAS-degrading or PFAS-destructing group, an electro-catalyst, or a combination thereof, where PFAS refers to per- and polyfluoroalkyl substances, and at least one CDI unit and at least one ECD unit are connected in series in such a manner that contaminated or salt water enters from a first end of the system, passes through an ECD and then a CDI unit or through a CDI and then an ECD unit, and finally exits from a second end to produce clean water.

### FIELD

The present invention relates to a method and apparatus of wastewater purification using a combined capacitive deionization and electrochemical disinfection cells. The method is ecofriendly, highly scalable, and cost-effective.

### BACKGROUND

Freshwater scarcity has become one of the most critical challenges facing humanity in the 21st century. Despite water covering 70% of the Earth's surface, only 3% of it is freshwater, and much of this limited resource is increasingly contaminated by pollutants. Climate change further exacerbates this crisis, raising global temperatures, accelerating water evaporation, and contributing to more frequent droughts and desertification. Groundwater, which provides nearly 50% of the world's drinking water, is also under threat due to overpumping. This practice not only depletes reserves but also leads to rising salinity levels and the accumulation of harmful contaminants. For example, overpumping in California has been linked to increased concentrations of dangerous arsenic, affecting both water quality and food safety.

Simultaneously, rapid population growth and urbanization are placing unprecedented pressure on water resources. Over the past 70 years, the global urban population has surged from 0.8 billion to 4.4 billion and is projected to reach 6.7 billion by 2050. This growth drives increased water demand across agricultural, industrial, and domestic sectors, often surpassing available supplies. As a result, the global water scarcity crisis has intensified, posing a significant threat to human health, economic stability, and environmental sustainability.

Addressing this crisis requires the development of innovative, energy-efficient, and environmentally sustainable technologies for water treatment and purification. A viable solution must effectively tackle two primary challenges: (i) the removal of chemical pollutants, such as metals, radioactive agents, and salt ions, and (ii) the elimination of biological contaminants, including microbes, bacteria, and viruses. While desalination methods are effective for chemical pollutant removal, disinfection processes are necessary to neutralize biological threats. An integrated system that combines these functionalities in an energy-efficient and scalable manner is essential to ensure access to safe, clean water at the point of need.

Capacitive deionization (CDI) is a practical and energy-efficient desalination technology for treating brackish and saltwater. CDI operates by applying a low voltage, typically in the range of 1.0 to 1.6 volts, across a pair of electrodes. This voltage induces the migration of dissolved ions in the water toward the oppositely charged electrodes, where they are adsorbed, effectively removing salts and other ionic impurities to produce potable water. CDI is recognized as a cost-effective desalination technique compared to conventional methods. For instance, the desalination cost per cubic meter using CDI is approximately $0.11, significantly lower than $0.35 for reverse osmosis (RO). This economic advantage, coupled with its simplicity and scalability, makes CDI an attractive solution for addressing global water scarcity.

In addition to desalination, CDI is highly effective for removing other ionic contaminants such as heavy metals and radioactive substances. These materials are adsorbed onto the electrodes through mechanisms such as electrostatic double-layer formation, intercalation, or pseudocapacitance processes, depending on the specific electrode materials used.

The main drawbacks of CDI include: low desalination capacity for high salinity water, relatively long discharge times, potential for electrode degradation over time, limited removal efficiency for high-concentration salt solutions, and concerns regarding energy efficiency compared to other desalination technologies; making it less suitable for large-scale applications with highly saline water sources. The most significant drawback of this method is its inability to remove impurities other than ions; these impurities include viruses, bacteria, organic contaminants, etc.

Electrochemical disinfection (ECD) has emerged as a promising and environmentally friendly technology for water treatments that require disinfection of biological or organic species. ECD is effective at inactivating a wide variety of microorganisms, including bacteria, viruses, and algae, under mild temperature and pressure conditions. The ECD process involves two primary mechanisms of action: direct oxidation and indirect oxidation. Direct oxidation implies that, at the electrode surface, the applied voltage facilitates the direct oxidation of microbial cells, leading to their immediate destruction. This process is highly effective for eliminating pathogens in the water. For indirect oxidation, ECD also generates reactive species within the bulk solution. These disinfecting species are produced through water oxidation and include hydroxyl radicals (OH·), atomic oxygen (O), hydrogen peroxide (H₂O₂), and ozone (O₃). These reactive oxygen species (ROS) are highly effective in neutralizing a broad range of microorganisms by disrupting their cellular structures.

However, there are several shortcomings associated with the ECD approach. The main drawbacks of electrochemical disinfection include: high energy consumption, potential formation of harmful byproducts depending on the water chemistry, electrode fouling, dependence on water quality, limited effectiveness against certain pathogens, and the cost of specialized electrodes like boron-doped diamond (BDD) which are often needed for optimal performance.

The present disclosure provides an innovative method and apparatus that take advantage of both electro-deionization purification systems and electrochemical disinfection purification systems in a manner that also reduces or eliminates the disadvantages of each. The disclosed apparatus provides clean drinking water where it is needed.

### SUMMARY

The present disclosure provides a method of producing clean water from contaminated or salt water, the method comprising integrating at least a capacitive deionization (CDI) cell and at least an electrochemical or electro-catalytic disinfection (ECD) cell to create a water purification system, wherein each CDI cell or ECD cell has two electrodes, an anode and a cathode, that are supplied with a voltage and current over the two electrodes, and at least one of the CDI and ECD cells comprises an electrode comprising graphene, MXene, a redox-active or Faradaic functional group or species, a PFAS-degrading or PFAS-destructing group, an electro-catalyst, or a combination thereof, where PFAS refers to per- and polyfluoroalkyl substances, and at least one CDI cell and at least one ECD cell are connected in series in such a manner that contaminated or salt water enters from a first end of the system, passes through an ECD and then a CDI cell or through a CDI and then an ECD cell, and finally exits from a second end to produce clean water.

The CDI unit may comprise a symmetric CDI or an asymmetric CDI, wherein the symmetric CDI is selected from a flow-through CDI, an osmosis CDI, a desalination battery, a flow-electrode CDI or a suspension-electrode CDI and wherein the asymmetric CDI is selected from a flow-through MCDI, an ion-selective flow-through CDI, a hybrid CDI, an inverted CDI, a flow-electrode CDI, or an asymmetric flow-electrode CDI.

The graphene material may be selected from pristine graphene having substantially no non-carbon element, graphene oxide, reduced graphene oxide, graphene fluoride, graphene chloride, graphene bromide, graphene iodide, hydrogenated graphene, doped graphene, nitrogenated graphene, chemically functionalized graphene, or a combination thereof. The doped graphene preferably comprises a dopant supported by or included in a graphene plane and the dopant is selected from B, Al, Ga, In, Sn, N, S, F, P, Sb, Bi, Se, a transition metal, or a combination thereof.

In certain embodiments, the MXene is in a form of nanoparticles or nano-film having a diameter or thickness from approximately 1 nm to 100 nm.

In some embodiments, the redox-active species or Faradaic functional group is selected from the group consisting of transition metal oxides, metal hydroxides, metal sulfides, metal nitrides, conducting polymers, Prussian Blue Analogues (PBA), Prussian White Analogues (PWA), and combinations thereof. Examples of metal oxides used as electrode materials for pseudocapacitor are manganese oxides (MnO₂), vanadium oxide (V₂O₃), ruthenium oxide (RuO₂), TiO₂, Nb₂O₅, and MoOₓ (x=1-4). These redox-active species or Faradaic functional group are preferably in the form of nano-particles or thin film (having a diameter or thickness from 0.5 nm to 100 nm, preferably 1-10 nm) that are supported by or bonded to an electrode comprising a graphene or MXene material.

The conductive polymers are preferably selected from the group consisting of polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly [(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, derivatives thereof, copolymers thereof, and combinations thereof.

In some preferred embodiments, the PFAS-degrading or PFAS-destructing species or group is selected from a transition metal oxide (e.g., MnO₄, Fe₃O₄, SnO₂, PbO₂, etc.), a mixed transition metal oxide (e.g., MFe₂O₄, M=Mn, Co, Ni, Co, Zn, etc.), O-terminated MXene, B/N-doped diamond, Ti/SnO₂—Sb/PbO₂, Magnéli-phase Ti₄O₇, Platinum, iridium oxide (IrO₂), ruthenium oxide, (RuO₂), Ti/SnO₂—Sb—Bi, Ti/SnO₂—Sb, Ti/SnO₂—Sb/PbO₂, Ti/SnO₂—Sb/MnO₂, Ti/SnO₂—Sb—Ce, Ti/SnO₂—Sb/PbO₂—Ce, Ti/SnO₂—Sb₂O₅/PbO₂, Ti/SnO₂—Sb₂O₅/PbO₂—PVDF (0.5-1% wt), Ti/SnO₂—Sb/Yb—PbO₂, Ti/SnO₂—Sb—PbO₂, Ti/SnO₂—Sb—Yb, Ti/SnO₂—Sb/Yb—PbO₂, Ti/SnO₂—Sb₂O₅—Bi₂O₃, Ti/PbO₂, Ti/TiO₂—NTs/PbO₂, Ti/TiO₂—NTs/Ag₂O/PbO₂, boron-doped diamond (BDD), B/N-doped diamond (BND), Nb/BDD, Si/BDD, Ti/BDD-BND, nitrogen-doped diamond (NDD), Si/MCD (microcrystalline diamond), Nb/UNCD (ultranano-crystalline diamond), BDD/PbO₂, BDD/SnO₂, BDD/SnO₂—F, Magn\acute{ }eli phase titanium suboxide (TSO), or a combination thereof.

It may be noted that the disclosed water purification system is capable of deactivating or removing many of the commonly found organic and biological contaminants, such as humic acid, alginate, benzoic acid, phenol, 4-chlorophenol, and perchlorate, just to name a few.

The electro-catalyst may comprise at least one of: a metal, a metal alloy, a metal oxide, a metal salt, a metal hydride, a metal sulfide, a metal phosphide, or a metal-containing compound; wherein the metal is selected from a group of elements consisting of noble metal elements, alkaline and alkaline earth metal elements, transition metal elements, rare earth metal elements, and low melting point metal elements. In some preferred embodiments, the electro-catalyst is a metal or metal alloy selected from the group consisting of noble metals, alkaline metals, transition metals, rare earth metals, and low melting point metals.

The water purification system may comprise at least two CDI units and two ECD units that form at least two water flow channels assembled in parallel wherein each of the channels comprises at least one ECD unit and at least one CDI unit connected in series.

The present disclosure provides a method of producing clean water from contaminated or salt water, the method comprising combining at least a capacitive deionization (CDI) unit and at least an electrochemical or electro-catalytic disinfection (ECD) unit to create a water purification system.

In some preferred embodiments, at least one of the CDI and ECD units comprises an electrode comprising graphene, MXene, a redox-active species or Faradaic functional group, a PFAS-degrading or PFAS-destructing group, an electro-catalyst, or a combination thereof, where PFAS refers to per- and polyfluoroalkyl substances.

A particularly desirable embodiment of the disclosure is a method of enhancing the electrochemical oxidation degradation of per- and polyfluoroalkyl substances (PFAS) in water, the method comprising: (a) using a doped graphene electrode in an ECD device, wherein the graphene is doped with at least one dopant selected from the group consisting of nitrogen, boron, fluorine, sulfur, phosphorus, transition metals, metal oxides, graphene quantum dots, single-atom catalysts, dual-dopants, and heterojunctions with other 2D materials; and (b) applying an electrical potential to the doped graphene electrode to generate reactive oxygen species (ROS) that degrade PFAS.

The present disclosure introduces the use of graphene, MXene, and MnFe₂O₃ nanoparticles (as an example of electro-active material or catalyst) to fabricate novel electrodes for electro-catalytic or electrochemical deionization (ECD) and capacitive deionization (CDI) applications. Conventional carbon materials (e.g., activated carbon particles) are well-known for their ability to remove ions via the electrical double layer (EDL) formation mechanism. However, activated carbons have a significant proportion of their pores or surface areas not accessible to liquid or liquid-borne contaminants and mechanisms relying solely on EDL have yet to achieve significant breakthroughs in capacitive performance for commercial applications. In the instant disclosure, we offer a new method that makes use of graphene and MXene materials as an electrode material in a CDI and/or ECD units. Further, we have discovered that redox and faradaic active materials (which are based on redox or faradaic reactions), when coupled with a graphene and/or MXene material, can be highly effective for purifying contaminated water.

Materials such as MnFe₂O₄ and MXene can offer competitive electrosorption capacities compared to EDL-based systems, along with faster electrosorption/desorption properties. To scale the synergistic properties of MXene nanosheets to the macroscopic level, constructing foam-like 3D structures, such as 3D reduced graphene oxide (3DrGO) with hierarchical pores, is an effective strategy to prevent MXene restacking issues. Combinations of graphene and MXene materials show unexpected synergistic effects that lead to significantly improved effectiveness in water purification.

In the presently disclosed water purification system, graphene in the form of 3D reduced graphene oxide (as an example), combined with MXene and MnFe₂O₄, are used to fabricate the ECD electrodes. MXene exhibits properties that make it an excellent candidate for generating reactive oxygen species (ROS) in electrochemical or photocatalytic systems. Its conductive nature, large surface area, transition metal redox activity, and tunable surface chemistry contribute to its ability to catalyze ROS production, which can be applied in water disinfection and pollutant degradation.

Additionally, manganese (Mn) and iron (Fe) in MnFe₂O₄ exist in multiple oxidation states (Mn²⁺/Mn³⁺ and Fe²⁺/Fe³⁺), making them suitable for redox reactions where electrons are transferred to oxygen or other molecules, facilitating ROS generation. In electrochemical environments, manganese oxides (MnOₓ) and iron oxides can be used as catalysts for various oxidation reactions due to these valence state transitions, which are crucial for ROS generation.

The present disclosure introduces a strikingly simple, fast, scalable, environmentally friendly, and cost-effective method for delivering potable water at the point of need. Our device uniquely integrates capacitive deionization (CDI) and electrochemical disinfection (ECD) into a unified, single-process system, enabling the simultaneous removal of chemical and biological contaminants in one operational step. This integration enhances efficiency, simplifies the process, and eliminates the need for multiple treatment stages—a significant improvement over methods described in existing research. Additionally, the system is adaptable to diverse water sources, including heavily polluted industrial effluents and brackish groundwater, making it both versatile and practical for a wide range of water treatment applications. The durable electrode materials and robust system design ensure consistent performance over extended use, addressing the performance decline observed in other approaches after just 10 hours of operation. Furthermore, the device operates efficiently at lower voltages and is designed to integrate seamlessly with renewable energy sources such as solar or wind power, reducing both energy consumption and operational costs.

In certain embodiments, the disclosure provides an integrated and streamlined method for producing portable water by simultaneously removing chemical and biological contaminants using a unified capacitive deionization and electrochemical disinfection (CDI-ECD) system. Unlike conventional multi-stage approaches that separately address desalination and disinfection, this method combines both processes into a single operational step, ensuring efficiency and simplicity. In some preferred embodiments, as an example, the method comprises:
a) Synthesis of metal ferrite nanoparticles (MFe₂O₄), such as MnFe₂O₄, ZnFe₂O₄, or CoFe₂O₄, followed by the synthesis of three-dimensional reduced graphene oxide (rGO). The metal ferrite nanoparticles and rGO are then combined with MXene to fabricate advanced electrodes for capacitive deionization (CDI) and electrochemical disinfection (ECD) cells;
b) operating the ECD process with a voltage and waterflow for a length of time sufficient for generating reactive oxygen species (ROS) or other disinfecting agents to kill 99% of microbes in the water system, after that the disinfected water will be desalinated by the CDI system, in which the water will be circulated at the CDI system with a voltage and waterflow for a length of time sufficient for obtaining very high salt adsorption capacity (SAC);
c) recovering the CDI-ECD electrodes containing the ions or microbes absorbed during the desalination phase by reversing the voltage (or by lowering the voltage) applied across the electrodes. This causes the ions that were previously adsorbed to the electrodes to be released back into the cleaning water, effectively desorbing them. This reduces the charge buildup on the electrodes, allowing them to be ready for the next cycle of ion adsorption.

The instant disclosure provides a method of producing clean water from contaminated or salt water; the method comprises combining at least a capacitive deionization (CDI) cell and at least an electrochemical or electro-catalytic disinfection (ECD) cell to create a water purification system; wherein the system meets at least one of the following conditions: (i) the CDI cell comprises a symmetric CDI or an asymmetric CDI, wherein the symmetric CDI is selected from a flow-through CDI, an osmosis CDI, a desalination battery, a flow-electrode CDI, or a suspension-electrode CDI and wherein the asymmetric CDI is selected from a flow-through MCDI, an ion-selective flow-through CDI, a hybrid CDI, an inverted CDI, a flow-electrode CDI, or an asymmetric flow-electrode CDI; (ii) the system is a miniaturized water purification system that does not comprise a pump to drive a flow of the water stream; (iii) at least one of the CDI and ECD cells comprises an electrode comprising graphene, MXene, a redox-active or Faradaic functional group, a PFAS-degrading or PFAS-destructing group, an electro-catalyst, or a combination thereof, where PFAS refers to per- and polyfluoroalkyl substances; and (iv) the system does not contain a diamond.

The instant disclosure further provides an apparatus for producing clean water from contaminated or salt water, the apparatus comprising:
(a) at least a capacitive deionization (CDI) cell, having a flow channel disposed therein, and at least an electrochemical or electro-catalytic disinfection (ECD) cell, having a flow channel disposed therein, that are connected in series to form a first assembly, wherein the CDI flow channel has an entry end to receive water and an exit end to discharge water and the ECD flow channel has an entry port to receive water and an exit port to discharge water and wherein either one of the following two configurations is arranged: (i) the entry port of the ECD cell is connected to and in fluid communication with the exit port of the CDI cell, or (ii) the entry port of the CDI cell is connected to and in fluid communication with the exit port of the ECD cell;
(b) a first entry port, attached to or integral with one end of the first assembly, to receive contaminated or salt water and a first exit port, attached to or integral with one opposite end of the first assembly, to discharge clean water;
(c) at least an anode and a cathode associated with the CDI cell and at least an anode and a cathode associated with the ECD cell; and
(d) a first power supply applying a first voltage (electrical potential) between the anode and the cathode of the CDI cell (for separating and respectively capturing cations and anions in the water flowing through the CDI channel) and a second power supply applying a second voltage (electrical potential) between the anode and the cathode of the ECD cell (for degrading or decomposing chemical species in the water flowing through the ECD channel), wherein the first voltage is the same as or different than the second voltage; wherein the apparatus is operated in such a manner that the contaminated or salt water enters from a first end of the system, passes through an ECD and then a CDI cell or through a CDI and then an ECD cell, and finally exits from a second end to produce clean water.

In certain embodiments, the apparatus further comprises one or a plurality of pumps to drive a flow of water through the first entry port and discharge through the first exit port. However, in certain embodiments, no pump is used in a presently disclosed compact or miniature apparatus.

In some preferred embodiments, at least one of the CDI and ECD cells in the apparatus comprises an electrode comprising graphene, MXene, a redox-active species or Faradaic functional group, a PFAS-degrading or PFAS-destructing group, an electro-catalyst, or a combination thereof.

The apparatus may further comprise a second assembly comprising another CDI cell and another ECD cell that are connected in series and the first assembly and the second assembly are connected in parallel.

In the disclosed apparatus, the CDI cell may comprise a symmetric CDI or an asymmetric CDI, wherein the symmetric CDI is selected from a flow-through CDI, an osmosis CDI, a desalination battery, a symmetric flow-electrode CDI, or a suspension-electrode CDI and wherein the asymmetric CDI is selected from a flow-through MCDI, an ion-selective flow-through CDI, a hybrid CDI, an inverted CDI, or an asymmetric flow-electrode CDI.

### BRIEF DESCRIPTION OF THE DRAWINGS

FIG. 1 A schematic diagram illustrating the ECD-CDI apparatus: (1) the ECD cell contains two electrodes that generate reactive oxygen species (ROS) responsible for deactivating microbes, and (2) the CDI cell consists of two electrodes that separate ions from saline solutions through distinct separation mechanisms wherein the ECD and CDI cells are connected in series, according to certain embodiments of the present disclosure.

FIG. 2(A) Another schematic diagram illustrating two cells (ECD+CDI) connected in series to form an assembly; but there can be 3 cells (2 ECD cells+1 CDI cell or 2 CDI cells+1 ECD cell), or 4 cells, etc. that are connected in series to form an assembly;

FIG. 2(B) Another schematic diagram illustrating two assemblies connected in parallel wherein each assembly contains two cells (ECD+CDI) connected in series, according to certain embodiments of the present disclosure.

FIG. 3(A) Schematic of several types of symmetric CDI cells that can be incorporated in the presently disclosed water purifying systems.

FIG. 3(B) Schematic of several types of asymmetric CDI cells that can be incorporated in the presently disclosed water purifying systems.

FIG. 4 A process flow chart that summarizes the steps in practicing the disclosed method or operating the disclosed water purification system, according to some embodiments of the present disclosure.

### DETAILED DESCRIPTION

The present invention relates to a capacitive deionization-electrochemical disinfection (CDI-ECD) system designed to produce potable water by simultaneously removing chemical pollutants and eliminating biological contaminants. This invention provides an innovative solution for addressing freshwater scarcity by integrating capacitive deionization with electrochemical disinfection to deliver safe and clean drinking water efficiently. The invention introduces a novel CDI-ECD system that combines desalination and disinfection capabilities in a single, energy-efficient process, offering a compact solution for producing freshwater at the point of need.

In certain preferred embodiments, the present disclosure provides a method of producing clean water from contaminated or salt water, the method comprising integrating at least a capacitive deionization (CDI) cell and at least an electrochemical or electro-catalytic disinfection (ECD) cell to create a water purification system, wherein at least one of the CDI and ECD cells comprises an electrode comprising graphene, MXene, a redox-active or Faradaic functional group or species, a PFAS-degrading or PFAS-destructing group, an electro-catalyst, or a combination thereof, where PFAS refers to per- and polyfluoroalkyl substances, and at least one CDI cell and at least one ECD cell are connected in series in such a manner that contaminated or salt water enters from a first end of the system, passes through an ECD and then a CDI cell or through a CDI and then an ECD cell, and finally exits from a second end to produce clean water.

The CDI cell in the water purification may comprise a symmetric CDI or an asymmetric CDI, wherein the symmetric CDI is selected from a flow-through CDI, an osmosis CDI, a desalination battery, a flow-electrode CDI, or a suspension-electrode CDI and wherein the asymmetric CDI is selected from a flow-through MCDI, an ion-selective flow-through CDI, a hybrid CDI, an inverted CDI, a flow-electrode CDI, or an asymmetric flow-electrode CDI.

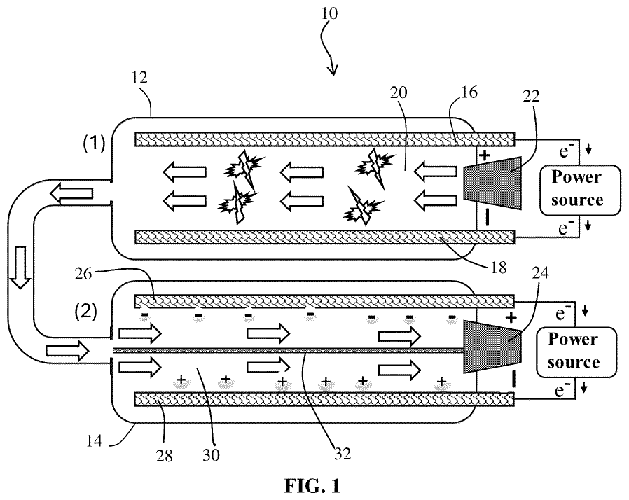

As schematically illustrated in FIG. 1, a water purifying system 10 contains (1) an ECD cell and (2) a CDI cell connected in series. The feed (contaminated or saline water to be purified) enters through an entry port 22 into the flow channel 20 of an ECD chamber 12. A power supply provides desired voltage/current over the positive electrode 16 and the negative electrode 18 of the ECD cell. The voltage level and the electrodes (including surface-bonded catalytic particles, chemical functional groups, redox species, etc.) may be designed and implemented to degrade or decompose biological species (e.g., bacteria) or organic species (e.g., PFAS) in the liquid stream. The liquid stream then flows into the channel 30 of a CDI chamber 14, which contains a positive electrode 26 and a negative electrode 28, which are electrically separated by a separator 32. The CDI cell is also provided with a power source that exerts a voltage or differential potential over the two electrodes, with the positive electrode attracting and capturing anions and the negative electrode attracting and capturing cations. The purified stream then exits through the opposite end 24.

Preferably the water purification does not contain a pump to drive the liquid flow so that the system can be very compact or a miniaturized system that is portable.

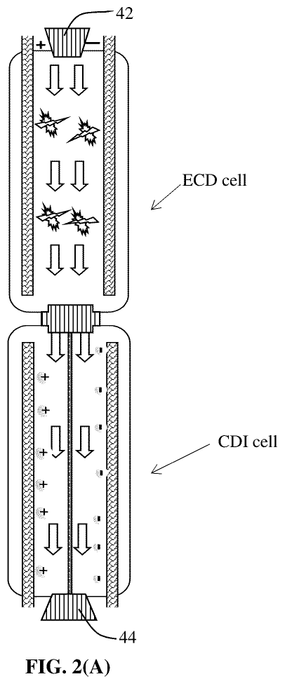

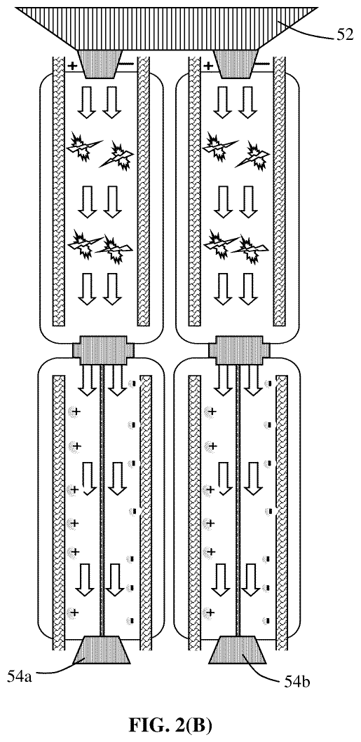

FIG. 2(A) shows another schematic diagram illustrating two cells (ECD+CDI) connected in series to form an assembly; but there can be 3 cells (2 ECD cells+1 CDI cell or 2 CDI cells+1 ECD cell), 4 cells, or n cells (n=any desirable number), etc. that are connected in series to form an assembly. In this configuration, the feed (contaminated or saline water) is fed through an entry port 42 and the purified water comes out from the exit port 44.

FIG. 2(B) shows, as another example, a schematic diagram illustrating two assemblies that are connected in parallel wherein each assembly contains two cells (ECD+CDI) connected in series, according to certain embodiments of the present disclosure. In this configuration, the feed (contaminated or saline water) is fed through an entry port 52 and the purified water comes out from the exit ports 44a and 44b.

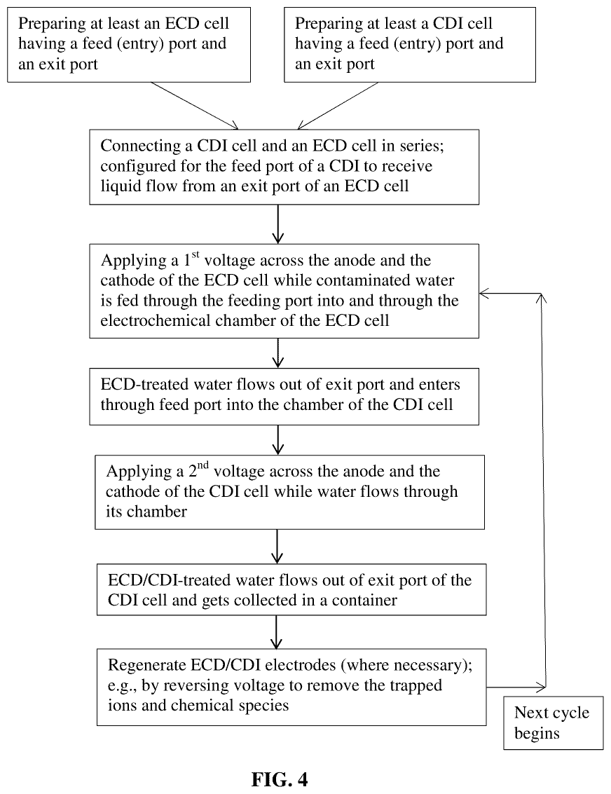

FIG. 4 shows a process flow chart that summarizes the steps in practicing the disclosed method or operating the disclosed water purification system.

The instant disclosure further provides an apparatus for producing clean water from contaminated or salt water, the apparatus comprising: (a) at least a capacitive deionization (CDI) cell, having a flow channel disposed therein, and at least an electrochemical or electro-catalytic disinfection (ECD) cell, having a flow channel disposed therein, that are connected in series to form a first assembly, wherein the CDI flow channel has an entry end to receive water and an exit end to discharge water and the ECD flow channel has an entry port to receive water and an exit port to discharge water and wherein either one of the following two configurations is arranged: (i) the entry port of the ECD cell is connected to and in fluid communication with the exit port of the CDI cell, or (ii) the entry port of the CDI cell is connected to and in fluid communication with the exit port of the ECD cell; (b) a first entry port, attached to or integral with one end of the first assembly, to receive contaminated or salt water and a first exit port, attached to or integral with one opposite end of the first assembly, to discharge clean water; (c) at least an anode and a cathode associated with the CDI cell and at least an anode and a cathode associated with the ECD cell; and (d) a first power supply applying a first voltage (electrical potential) between the anode and the cathode of the CDI cell (for separating and respectively capturing cations and anions in the water flowing through the CDI channel) and a second power supply applying a second voltage (electrical potential) between the anode and the cathode of the ECD cell (for degrading or decomposing chemical species in the water flowing through the ECD channel), wherein the first voltage is the same as or different than the second voltage; wherein the apparatus is operated in such a manner that the contaminated or salt water enters from a first end of the system, passes through an ECD and then a CDI cell or through a CDI and then an ECD cell, and finally exits from a second end to produce clean water.

In certain embodiments, the apparatus further comprises one or a plurality of pumps to drive a flow of water through the first entry port and discharge through the first exit port. However, in a presently disclosed compact or miniature apparatus, no pump is used.

In some preferred embodiments, at least one of the CDI and ECD cells in the apparatus comprises an electrode comprising graphene, MXene, a redox-active species or Faradaic functional group, a PFAS-degrading or PFAS-destructing group, an electro-catalyst, or a combination thereof.

The apparatus may further comprise a second assembly comprising another CDI cell and another ECD cell that are connected in series and the first assembly and the second assembly are connected in parallel.

In the disclosed apparatus, the CDI cell may comprise a symmetric CDI or an asymmetric CDI, wherein the symmetric CDI is selected from a flow-through CDI, an osmosis CDI, a desalination battery, a symmetric flow-electrode CDI, or a suspension-electrode CDI and wherein the asymmetric CDI is selected from a flow-through MCDI, an ion-selective flow-through CDI, a hybrid CDI, an inverted CDI, or an asymmetric flow-electrode CDI.

It may be noted that at least one of the CDI and ECD cells comprises at lease an electrode, either anode or cathode (or both anode and cathode), comprising graphene, MXene, a redox-active or Faradaic functional group or species, a PFAS-degrading or PFAS-destructing group, an electro-catalyst, or a combination thereof, where PFAS refers to per- and polyfluoroalkyl substances,

The graphene material may be selected from pristine graphene having substantially no non-carbon element, graphene oxide, reduced graphene oxide, graphene fluoride, graphene chloride, graphene bromide, graphene iodide, hydrogenated graphene, doped graphene, nitrogenated graphene, chemically functionalized graphene, or a combination thereof. The doped graphene preferably comprises a dopant supported by or included in a graphene plane and the dopant is selected from B, Al, Ga, In, Sn, N, S, F, P, Sb, Bi, Se, a transition metal, or a combination thereof.

In certain preferred embodiments, the water purification system does not contain a diamond in an ECD electrode or CDI electrode. Any doped diamond, such as boron-doped diamond (BDD), is very costly. Our B-doped graphene can be as effective in helping to destruct and remove organic or biological contaminants.

MXene is a group of 2D materials composed of transition metal carbides, carbonitrides, and nitrides with the general formula of Mₙ₊₁XₙT_{X}, where M is an early transition metal, such as Sc, Ti, V, and Cr, X represents carbon or nitrogen and T_{X} refers to surface termination molecules, such as —OH, —O, or —F groups. One MXene sheet usually consists of 3, 5, or 7 atomic layers, corresponding to M₂X, M₃X₂, or M₄X₃, respectively. There would be 2 more layers if the aforementioned functional termination groups are presented and bonded to the outer transition metal layers. The termination layers are the common results from the synthesis in acidic fluoride-containing solution. Apart from single metal carbides, such as Ti₃C₂ and Ti₄C₃, compounds with binary metals also exist, including Mo₂TiC₂, Mo₂Ti₂C₃. MXene materials are herein used as an electrode material in an ECD or CDI unit, mainly because of their metallic conductivity (9880 S cm⁻¹), high Li storage capacity (447.8 mA h g⁻¹), ultrahigh theoretical capacitance (1982 F cm⁻³) and hydrophilic surfaces.

In certain embodiments, the MXene is in a form of nanoparticles or nano-film having a diameter or thickness from approximately 1 nm to 100 nm.

In some embodiments, the redox-active species or Faradaic functional group is selected from the group consisting of transition metal oxides, metal hydroxides, metal sulfides, metal nitrides, conducting polymers, Prussian Blue Analogues (PBA), Prussian White Analogues (PWA), and combinations thereof. Examples of metal oxides used as electrode materials for pseudocapacitor are manganese oxides (MnO₂), vanadium oxide (V₂O₃), ruthenium oxide (RuO₂), TiO₂, Nb₂O₅, and MoOₓ (x=1-4). These redox-active species or Faradaic functional group are preferably in the form of nano-particles or thin film (having a diameter or thickness from 0.5 nm to 100 nm, preferably 1-10 nm) that are supported by or bonded to an electrode comprising a graphene or MXene material.

The conductive polymers are preferably selected from the group consisting of polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly [(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, derivatives thereof, copolymers thereof, and combinations thereof.

In some preferred embodiments, the PFAS-degrading or PFAS-destructing species or group is selected from is selected from a transition metal oxide (e.g., MnO₄, Fe₃O₄, SnO₂, PbO₂, etc.), a mixed transition metal oxide (e.g., MFe₂O₄, M=Mn, Co, Ni, Co, Zn, etc.), O-terminated MXene, B/N-doped diamond (BND), Ti/SnO₂—Sb/PbO₂, Magnéli-phase Ti₄O₇, Platinum, iridium oxide (IrO₂), ruthenium oxide, (RuO₂), Ti/SnO₂—Sb—Bi, Ti/SnO₂—Sb, Ti/SnO₂—Sb/PbO₂, Ti/SnO₂—Sb/MnO₂, Ti/SnO₂—Sb—Ce, Ti/SnO₂—Sb/PbO₂—Ce, Ti/SnO₂—Sb₂O₅/PbO₂, Ti/SnO₂—Sb₂O₅/PbO₂—PVDF (0.5-1% wt), Ti/SnO₂—Sb/Yb—PbO₂, Ti/SnO₂—Sb—PbO₂, Ti/SnO₂—Sb—Yb, Ti/SnO₂—Sb/Yb—PbO₂, Ti/SnO₂—Sb₂O₅—Bi₂O₃, Ti/PbO₂, Ti/TiO₂—NTs/PbO₂, Ti/TiO₂-NTs/Ag₂O/PbO₂, boron-doped diamond (BDD), Nb/BDD, Si/BDD, Ti/BDD-BND, nitrogen-doped diamond (NDD), Si/MCD (microcrystalline diamond), Nb/UNCD (ultranano-crystalline diamond), BDD/PbO₂, BDD/SnO₂, BDD/SnO₂—F, Magn\acute{ }eli phase titanium suboxide (TSO), or a combination thereof.

It may be noted that although boron-doped diamond (BDD) can be effective in breaking down certain organic and biological species, this type of electrode is extremely expensive due to the high costs of diamond. We have found that boron-doped graphene can be as effective as an ECD electrode material for the same contaminant-destructing function, yet at a much lower cost. Preferably, these PFAS-degrading or chemical-destructing species are supported by or bonded to a CDI electrode or ECD electrode that comprises a graphene, a MXene, or both. Our system can be BDD-free or diamond-free.

The electro-catalyst may comprise at least one of: a metal, a metal alloy, a metal oxide, a metal salt, a metal hydride, a metal sulfide, a metal phosphide, or a metal-containing compound; wherein the metal is selected from a group of elements consisting of noble metal elements, alkaline and alkaline earth metal elements, transition metal elements, rare earth metal elements, and low melting point metal elements. In some preferred embodiments, the electro-catalyst is a metal or metal alloy selected from the group consisting of noble metals, alkaline metals, transition metals, rare earth metals, and low melting point metals.

Capacitive deionization (CDI) is a practical and energy-efficient desalination technology for treating brackish and saltwater. CDI operates by applying a low voltage, typically in the range of 1.0 to 1.6 volts, across a pair of electrodes. This voltage induces the migration of dissolved ions in the water toward the oppositely charged electrodes, where they are adsorbed, effectively removing salts and other ionic impurities to produce potable water. CDI is recognized as a cost-effective desalination technique compared to conventional methods. For instance, the desalination cost per cubic meter using CDI is approximately $0.11, significantly lower than $0.35 for reverse osmosis (RO). This economic advantage, coupled with its simplicity and scalability, makes CDI an attractive solution for addressing global water scarcity.

In the presently disclosed water purification system and method, there are no restrictions on the type of CDI units or on the type of ECD units that can be used.

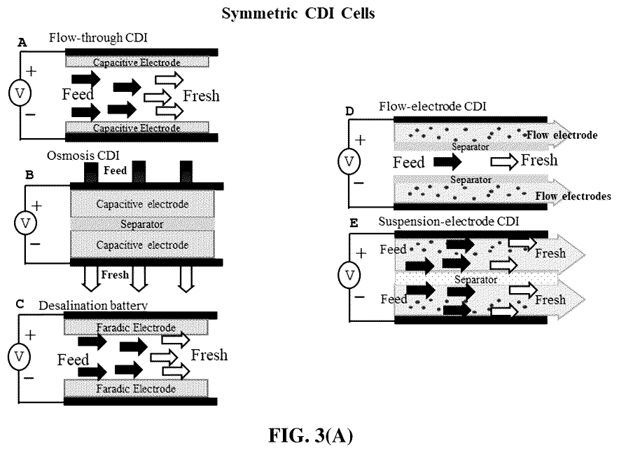

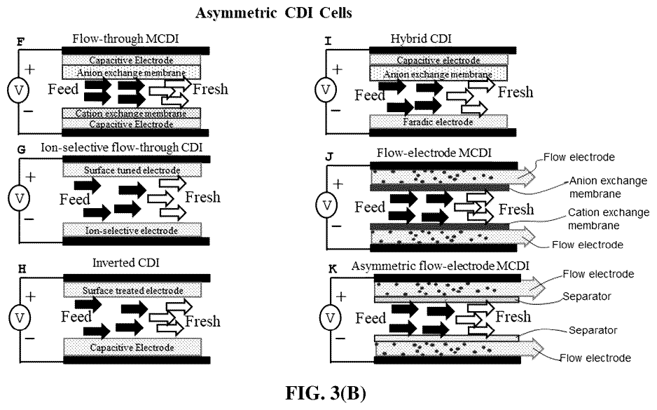

There are mainly two kinds of CDI cells: symmetric CDI cells (FIG. 3(A)) and asymmetric CDI cells (FIG. 3(B)). The symmetric CDI may be selected from a flow-through CDI, an osmosis CDI, a desalination battery, a flow-electrode CDI or a suspension-electrode CDI. The asymmetric CDI may be selected from a flow-through MCDI, an ion-selective flow-through CDI, a hybrid CDI, an inverted CDI, a flow-electrode CDI, or an asymmetric flow-electrode CDI.

The first symmetric CDI device is flow-through CDI (Cell A in FIG. 3(A)). An osmosis CDI is a device in which the feed flows directly osmosis the electrodes (Cell B in FIG. 3(A)). The osmosis CDI typically allows for faster cell charging than flow-through CDI. The desalination battery utilizes two battery-type electrodes for desalination (Cell C in FIG. 3(A)). This device is useful for high salinity water desalination and allows high salt sorption. However, the desalination battery is often found to be less stable due to the Faradaic reactions. A flow-electrode CDI leverages carbon flow electrodes, or carbon slurry electrodes (Cell D in FIG. 3(A)). This flow-electrode CDI enables compact and low resistance systems. One can also make use of a form of “electrodes in motion” by using the moving wires to perform desalination or a suspension-electrode CDI for desalting brackish and seawater by using carbon suspensions (Cell E in FIG. 3(A)).

Asymmetric CDI devices include, for instance, the membrane CDI (MCDI) (Cell F in FIG. 3(B)). In the flow-through MCDI, a free-standing cation exchange membrane is placed before the cathode, and a free-standing anion exchange membrane is placed before the anode. After adding membranes, the charge efficiency can be effectively improved due to the membranes block co-ions from carrying parasitic current. Alternatively, one can directly graft ion-selective groups onto porous carbon (Cell G in FIG. 3(B)), which can reduce the internal resistance and production cost. In the ion-selective flow-through CDI, the functional groups can minimize the co-ion expulsion effect and increase the charge efficiency. An inverted CDI makes use of an anode with net negative surface charges and a cathode with net positive surface charges (Cell H in FIG. 3(B)). The salt separation in this system can be achieved in an opposing manner to the conventional CDI system; when the system is charged using a power source, cations and anions are desorbed at the anode and cathode, respectively. A hybrid CDI (Cell I in FIG. 3(B)) can exhibit more than double the ion removal sorption capacity than a typical CDI system. A membrane CDI process device is particularly useful for seawater desalination (Cell J in FIG. 3(B)). A flowing suspension carbon can be applied to the desalination of high salinity streams. However, in practical cases, the operation voltage of flow-electrode CDI is usually limited by the decomposition potential of water, which is not beneficial for the desalinization performance. A novel asymmetric flow-electrode CDI device entails using an activated carbon/MnO₂ suspension as the positive electrode and activated carbon suspension as the negative electrode (Cell K in FIG. 3(B)). In the asymmetric flow-electrode CDI, the operation voltage can be improved to be 1.8 V, and a high salt removal efficiency is much higher than that for conventional flow-electrode CDI.

The regeneration of CDI electrodes is a critical operational step that restores the system's capacity to remove ions. This can be achieved through two methods:
1—Switching off the applied voltage: When the system is deactivated, the polarized voltage ceases, and the adsorbed ions are released back into the water. The resulting brine can be discharged as waste.
2—Reversing the polarity: By reversing the polarity of the applied voltage, the adsorbed ions desorb from the electrodes and re-enter the water. This regeneration process typically takes a few minutes, depending on the system design and the degree of ion saturation on the electrodes.

Thus, the disclosed method may further comprise a step of reversing the electric potential (voltage) or lower the voltage to remove captured ions or chemical species from an electrode of a CDI or ECD cell.

In addition to desalination, CDI is highly effective for removing other ionic contaminants such as heavy metals and radioactive substances. These materials are adsorbed onto the electrodes through mechanisms such as electrostatic double-layer formation, intercalation, or pseudocapacitance processes, depending on the specific electrode materials used.

One of the most critical factors influencing the performance of a CDI system is the selection and fabrication of electrode materials. Since the inception of this technology, significant research has focused on developing electrode materials that achieve high salt removal efficiency at fast rates with minimal energy consumption. Carbon-based materials have been extensively studied due to their favorable properties such as high conductivity, large surface area, and chemical stability. Examples include activated carbon, carbon aerogel, carbon nanotubes, graphene sponge, graphene oxide, reduced graphene oxide, and carbon composites.

We have discovered that various types of graphene materials can be incorporated in the electrodes of both the CDI and ECD units. These include pristine graphene (having substantially no non-carbon element), graphene oxide (having up to 50% by weight of oxygen), reduced graphene oxide (0.01-1.00% oxygen), graphene fluoride, graphene chloride, graphene bromide, graphene iodide, hydrogenated graphene, doped graphene, nitrogenated graphene, chemically functionalized graphene, or a combination thereof. The doped graphene preferably comprises a dopant supported by or included in a graphene plane and the dopant is selected from B, Al, Ga, In, Sn, N, S, F, P, Sb, Bi, Se, a transition metal, or a combination thereof.

The second type of device used in the presently disclosed water purification system is electrochemical or electro-catalytic disinfection (ECD), which is a powerful and environmentally friendly technology for water treatment due to its several advantages:
1—Environmental Compatibility: The process does not require the use of chemicals, making it more sustainable and reducing the potential for harmful by-products.
2—Suitability for Portable Solutions: ECD can be easily adapted for portable water treatment devices, offering flexibility for a wide range of applications, including emergency or remote settings.
3—Low Operational Costs: ECD operates efficiently at ambient temperature and pressure, reducing the need for complex equipment or energy-intensive processes.
4—Renewable Energy Compatibility: The system can be powered by various renewable energy sources, making it an energy-efficient and sustainable solution.
5—Broad Spectrum Microbial Inactivation: ECD is effective at inactivating a wide variety of microorganisms, including bacteria, viruses, and algae, under mild temperature and pressure conditions.
   The ECD process involves two primary mechanisms of action:
1) Direct Oxidation: At the electrode surface, the applied voltage facilitates the direct oxidation of microbial cells, leading to their immediate destruction. This process is highly effective for eliminating pathogens in the water.
2) Indirect Oxidation: In addition to direct oxidation, ECD also generates reactive species within the bulk solution. These disinfecting species are produced through water oxidation and include hydroxyl radicals (OH·), atomic oxygen (O), hydrogen peroxide (H₂O₂), and ozone (O₃). These reactive oxygen species (ROS) are highly effective in neutralizing a broad range of microorganisms by disrupting their cellular structures.

The generation of these reactive species can be described through the following chemical reactions (Equations 1-8)

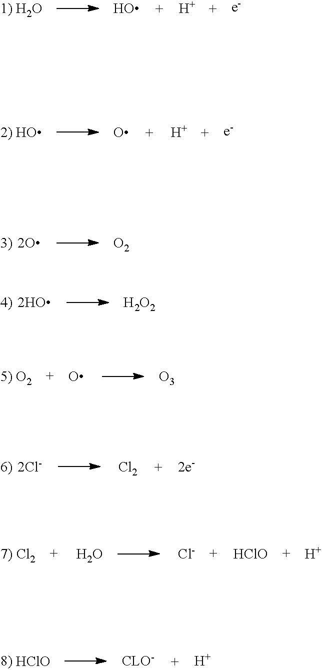

The present disclosure introduces the use of graphene, MXene, and MnFe₂O₃ nanoparticles (as an example of electro-active material or catalyst) to fabricate novel electrodes for electro-catalytic or electrochemical deionization (ECD) and/or capacitive deionization (CDI) applications. Conventional carbon materials (e.g., activated carbon particles) are well-known for their ability to remove ions via the electrical double layer (EDL) formation mechanism. However, activated carbons have a significant proportion of their pores or surface areas not accessible to liquid or liquid-borne contaminants and mechanisms relying solely on EDL have yet to achieve significant breakthroughs in capacitive performance for commercial applications. In the instant disclosure, we offer a new method that makes use of graphene and MXene materials as an electrode material in a CDI and/or ECD units. Further, we have discovered that redox and faradaic active materials (which are based on redox or faradaic reactions), when coupled with a graphene and/or MXene material, can be highly effective for purifying contaminated water.

Materials such as MnFe₂O₄ and MXene can offer competitive electrosorption capacities compared to EDL-based systems, along with faster electrosorption/desorption properties. To scale the synergistic properties of MXene nanosheets to the macroscopic level, constructing foam-like 3D structures, such as 3D reduced graphene oxide (3DrGO) with hierarchical pores, is an effective strategy to prevent MXene restacking issues. Combinations of graphene and MXene materials show unexpected synergistic effects that lead to significantly improved effectiveness in water purification.

In the presently disclosed water purification system, graphene in the form of 3D reduced graphene oxide (as an example), combined with MXene and MnFe₂O₄, are used to fabricate the ECD electrodes. MXene exhibits properties that make it an excellent candidate for generating reactive oxygen species (ROS) in electrochemical or photocatalytic systems. Its conductive nature, large surface area, transition metal redox activity, and tunable surface chemistry contribute to its ability to catalyze ROS production, which can be applied in water disinfection and pollutant degradation.

Additionally, manganese (Mn) and iron (Fe) in MnFe₂O₄ exist in multiple oxidation states (Mn²⁺/Mn³⁺ and Fe²⁺/Fe³⁺), making them suitable for redox reactions where electrons are transferred to oxygen or other molecules, facilitating ROS generation. In electrochemical environments, manganese oxides (MnOₓ) and iron oxides can be used as catalysts for various oxidation reactions due to these valence state transitions, which are crucial for ROS generation.

Electrochemical oxidation shows promise as a potential solution for treating water contaminated with poly- and perfluoroalkyl substances (PFAS), offering a method to degrade these persistent pollutants, but challenges remain regarding efficiency, potential byproduct formation, and scaling up to industrial applications.

Electrochemical oxidation breaks down PFAS molecules by direct electron transfer at the anode surface, generating reactive oxygen species (like hydroxyl radicals) which can further degrade the contaminant into smaller, less harmful compounds. This approach has multiple potential benefits: (a) complete mineralization: Under optimal conditions, electrochemical oxidation can completely mineralize PFAS into harmless compounds like carbon dioxide and fluoride ions; (b) No additional chemicals: Unlike some other treatment methods, electrochemical oxidation primarily relies on electricity to drive the degradation process; and (c) Flexibility: Can be adapted to treat different types of PFAS depending on the electrode material and operating conditions.

However, there are multiple challenges: (A) High energy consumption: Achieving significant PFAS degradation often requires high energy input, which can impact the cost-effectiveness of the process; (B) Byproduct formation: Depending on the electrode material and operating parameters, potentially harmful byproducts like chlorinated compounds can be formed; and (C) Electrode selection: Choosing the right electrode material is crucial for optimal PFAS degradation, as different materials have varying reactivity and selectivity.

The presently disclosed technology enables realization of electrochemical oxidation's great potential for PFAS remediation by effectively addressing efficiency concerns and optimizing treatment parameters to ensure complete contaminant removal and minimal byproduct generation.

The instant disclosure provides a method of producing clean water from contaminated or salt water; the method comprises combining at least a capacitive deionization (CDI) cell and at least an electrochemical or electro-catalytic disinfection (ECD) cell to create a water purification system; wherein the system meets at least one of the following conditions: (i) the CDI cell comprises a symmetric CDI or an asymmetric CDI, wherein the symmetric CDI is selected from a flow-through CDI, an osmosis CDI, a desalination battery, a flow-electrode CDI, or a suspension-electrode CDI and wherein the asymmetric CDI is selected from a flow-through MCDI, an ion-selective flow-through CDI, a hybrid CDI, an inverted CDI, a flow-electrode CDI, or an asymmetric flow-electrode CDI; (ii) the system is a miniaturized water purification system that does not comprise a pump to drive a flow of the water stream; (iii) at least one of the CDI and ECD cells comprises an electrode comprising graphene, MXene, a redox-active or Faradaic functional group, a PFAS-degrading or PFAS-destructing group, an electro-catalyst, or a combination thereof, where PFAS refers to per- and polyfluoroalkyl substances; and (iv) the system does not contain a diamond.

The following examples serve to provide the best modes of practice for the present invention and should not be construed as limiting the scope of the invention:

### Example 1: Preparation of Ti₃C₂Tₓ MXene Materials with Controlled Termination Groups

The four main steps for synthesizing Ti₃C₂Tₓ MXene materials include the synthesis of a Ti₃AlC₂ MAX phase, pre-etch HCl wash of the MAX phase, selective A-layer etching of the MAX phase, and exfoliation of multilayered MXenes to single-to-few-layer flakes via delamination. The Ti₃AlC₂ MAX phases can be synthesized from a wide range of raw materials, such as pure elemental powders of Ti, Al, and C, or compounds containing metals and carbon, such as TiH₂, TiC, and Al₄C₃. The use of excess metal, including more than two times the moles of aluminum (instead of one mole), and 0.25 more moles of Ti, gives the highest purity Ti₃AlC₂ MAX with the least amount of X-site substitutional impurities. All these variables control the synthesis yield and quality of the resulting MXene. The precursor powder mixture for a MAX synthesis is usually dry mixed in a horizontal tumbler mixer, 3D tumbling mixer, and a ball mill for 2 to 24 hours or more in air, followed by reactive sintering at approximately 1350-1400° C. under a controlled environment.

For the purpose of optimizing Ti₃AlC₂MAX, the excess-metal route was followed with Ti, TiC, and Al as our raw materials in a 1.25Ti:2.2Al:2TiC ratio and milled for 18 h in a jar (tumbler) mill with zirconia media at 60 RPM, followed by reactive sintering in a tube furnace at 1400° C. for 4 h under an argon flow. Ti₃AlC₂ MAX was also made using the stoichiometric mixing of 1Ti:1Al:2TiC mole ratio under the same conditions (labelled as regular-Ti₃AlC₂) to compare the resulting Ti₃C₂Tₓ MXene. To remove the intermetallic impurities from the Ti₃AlC₂ MAX, the powders were treated for 18 h in 9 M HCl at room temperature (RT) under stirring. The HF—HCl mixed acids were used as the etchant and the etching was conducted at 35° C. for 24 h to produce Ti₃C₂Tₓ MXene. To obtain few-layer MXene, DMSO was used as an intercalant (24 hours) and the resulting intercalated Ti₃C₂Tₓ was subjected to ultrasonication delamination.

Experimental results have shown that an increase in the concentration of O termination groups on an MXene surface could lead to a more effective electrode for an ECD cell. To increase the concentration of O termination groups on an MXene surface, several post-synthesis chemical treatments were conducted. These included exposure to oxygen plasma, hydrothermal reactions in alkaline solutions, and controlled oxidation processes, which effectively replaced other termination groups (like F) with oxygen-based functional groups like —O or —OH, thereby enhancing the O termination level on the MXene surface. The specific method depends on the desired degree of O-functionalization and the MXene type itself. The initial etching process used to create the MXene can influence the termination groups present. For instance, the etching solution composition (e.g., using a higher proportion of water in the HF-based etchant) can favor the formation of O-terminated MXene. Exposing MXene to oxygen plasma can introduce oxygen functional groups onto the surface, increasing the O termination concentration. Treating MXene with a basic solution (like NaOH or KOH) can promote the replacement of other terminal groups with hydroxyl groups (—OH) which are considered a form of O termination.

Nano-sheets of Ti₃C₂Tₓ MXene and graphene oxide sheets (prepared in Example 6) were dispersed in water to form a slurry, which was spray-dried to form porous graphene particulates comprising Ti₃C₂Tₓ MXene nano-sheets enclosed by GO sheets. These graphene/MXene balls can be used to make CDI electrodes using the well-known slurry coating process for making electrodes for supercapacitor or lithium-ion battery cells.

### Example 2: Preparation of MXene Nano-Sheets (with Termination Group O) Entrapped in a 3D Graphene Structure

The Ti₃AlC₂ MAX phase was synthesized by mixing TiC (~2 μm particle size, 99.5% purity), Ti (<44 μm particle size, 99.9% purity), and Al (200 mesh size, 99% purity) powders for 5 min in an agate mortar and pestle. The TiC/Ti/Al molar ratio was 2:1:1. The mixed powder was loaded in an alumina crucible and inserted in a tube furnace. The furnace was first pumped down and purged with Ar twice and then filled with Ar gas. The powder was heated up with a rate of 5° C. min⁻¹ to 1450° C., at which it was held for 2 h, prior to being cooled to 50° C. at a rate of 5° C. min⁻¹. The slightly sintered MAX phase obtained was crushed using an agate mortar and pestle until an average particle size of 32 μm was attained.

Then, 0.26 g of LiF in 20 mL of deionized water was transferred to a hot stirring plate, stirred for 15 min at 80° C. and then left to cool down to room temperature. Afterward, 100 mg of the Ti₃AlC₂ MAX phase was added to the LiF/water mixture to create a 5 mg mL⁻¹ MAX phase suspension. The reason for adding a LiF amount higher than the solubility of LiF in water (~0.05 M at 25° C.) is to create a F ion reservoir, since the dissolved amount of LiF does not provide the sufficient amount of F ions theoretically needed to etch all of the Al in Ti₃AlC₂ forming Ti₃C₂T_{z} (which is 0.08 M of LiF). The suspension of Ti₃AlC₂+LiF was first homogenized using a vortex homogenizer and then transferred to an ultrasonicator to produce delaminated Ti₃C₂T_{z} sheets.

In order to prepare CDI and ECD electrodes, porous 3D graphene foam containing delaminated MXene sheets with abundant O-based termination groups was prepared from hydrothermally reduced graphene oxide. This was motivated by our discoveries that heating MXene in an aqueous environment under pressure can facilitate the formation of O-terminated groups and that graphene oxide sheets can be self-assembled into a 3D reduced graphene oxide foam structure under similar hydrothermal conditions.

In a typical procedure, a self-assembled graphene hydrogel (SGH) was prepared by dispersing delaminated Ti₃C₂T_{z} sheets and graphene oxide sheets (GO, prepared in Example 6 below) in water. The resulting suspension was sealed in a Teflon-lined autoclave and heated at 180° C. for 12 h. Upon water removal by freeze-drying, we obtained a porous 3D graphene structure comprising MXene sheets residing in the pores.

### Example 3: Preparation of Discrete Nano Graphene Platelets (NGPs) and RGO Foam

Chopped graphite fibers with an average diameter of 12 μm and natural graphite particles were separately used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 5-16 hours of reaction, the acid-treated graphite fibers or natural graphite particles were filtered and washed thoroughly with deionized water until the pH level of the solution reached 6. After being dried at 100° C. overnight, the resulting graphite intercalation compound (GIC) or graphite oxide fiber was re-dispersed in water and/or alcohol to form a slurry.

In one sample, five grams of the graphite oxide fibers were mixed with 2,000 ml alcohol solution consisting of alcohol and distilled water with a ratio of 15:85 to obtain a slurry mass. Then, the mixture slurry was subjected to ultrasonic irradiation with a power of 200 W for various lengths of time. After 20 minutes of sonication, GO fibers were effectively exfoliated and separated into thin graphene oxide sheets with oxygen content of approximately 23%-31% by weight. The resulting suspension contains GO sheets being suspended in water. A chemical blowing agent (hydrazo dicarbonamide) was added to the suspension just prior to casting.

The resulting suspension was then cast onto a stainless steel mold having a rectangular groove. A wiper was used to exert shear stresses, inducing GO sheet orientations. The wet GO suspension was then dried. The GO suspension was then subjected to heat treatments that involved an initial thermal reduction temperature of 80-350° C. for 1-8 hours, followed by heat-treating at a second temperature of 1,500-2,850° C. for 0.5 to 5 hours. The rectangular shaped reduced graphene oxide foam slabs were used as electrodes in a CDI cell.

### Example 4: Preparation of Single-Layer Graphene Sheets and Graphene Foam from Meso-Carbon Micro-Beads (MCMBs)

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours.

The GO sheets contain oxygen proportion of approximately 35%-47% by weight for oxidation treatment times of 48-96 hours. GO sheets were suspended in water. Baking soda (5-20% by weight), as a chemical blowing agent, was added to the suspension just prior to casting. The suspension was then cast onto a steel surface. Several samples were cast, some containing a blowing agent and some not. The resulting GO layers, after removal of liquid, have a thickness that can be varied from approximately 1 mm to 10 mm.

These GO layers, with or without a blowing agent contained therein, were then subjected to heat treatments that involve an initial (first) thermal reduction temperature of 80-500° C. for 1-5 hours. This first heat treatment generated a graphene foam sheet. However, the graphene domains in the foam wall can be further perfected (re-graphitized to become more ordered or having a higher degree of crystallinity and larger lateral dimensions of graphene planes, longer than the original graphene sheet dimensions due to chemical merging) if the foam is followed by heat-treating at a second temperature of 1,500-2,850° C. Some graphene foam layers were then bonded to carbon-coated Al foils to produce electrodes for CDI cells.

### Example 5: Preparation of Pristine Graphene Foam (0% Oxygen)

Recognizing the possibility of the high defect population in GO sheets acting to reduce the conductivity of individual graphene plane, we decided to study if the use of pristine graphene sheets (non-oxidized and oxygen-free, non-halogenated and halogen-free, etc.) can lead to a graphene foam having a higher thermal conductivity. Pristine graphene sheets were produced by using the direct ultrasonication or liquid-phase production process.

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements.

Various amounts (1%-30% by weight relative to graphene material) of chemical bowing agents (N, N-Dinitroso pentamethylene tetramine or 4. 4′-Oxybis (benzenesulfonyl hydrazide) were added to a suspension containing pristine graphene sheets and a surfactant. The suspension was then cast onto a glass surface using a doctor's blade to exert shear stresses, inducing graphene sheet orientations. Several samples were cast, including one that was made using CO₂ as a physical blowing agent introduced into the suspension just prior to casting). The resulting graphene suspension layers, after removal of liquid, have a thickness that can be varied from approximately 0.1 mm to 50 mm.

The graphene layers were then subjected to heat treatments that involve an initial (first) thermal reduction temperature of 80-1,500° C. for 1-5 hours. This first heat treatment generated a graphene foam structure. Some of the pristine foam samples were then subjected to a second temperature of 1,500-2,850° C. to determine if the graphene domains in the foam wall could be further perfected (re-graphitized to become more ordered or having a higher degree of crystallinity). Graphene foam structures were cut into rectangular pieces of desired dimensions for use as CDI or ECD electrodes.

### Example 6: Preparation of Graphene Oxide (GO) Suspension from Natural Graphite and of Subsequent GO Foams

Graphite oxide was prepared by oxidation of graphite flakes with an oxidizer liquid consisting of sulfuric acid, sodium nitrate, and potassium permanganate at a ratio of 4:1:0.05 at 30° C. When natural graphite flakes (particle sizes of 14 μm) were immersed and dispersed in the oxidizer mixture liquid for 48 hours, the suspension or slurry appears and remains optically opaque and dark. After 48 hours, the reacting mass was rinsed with water 3 times to adjust the pH value to at least 3.0. A final amount of water was then added to prepare a series of GO-water suspensions. We observed that GO sheets form a liquid crystal phase when GO sheets occupy a weight fraction >3% and typically from 5% to 15%.

By dispensing and coating the GO suspension on a polyethylene terephthalate (PET) film in a slurry coater and removing the liquid medium from the coated film we obtained a thin film of dried graphene oxide. Several GO film samples were then subjected to different heat treatments, which typically include a thermal reduction treatment at a first temperature of 100° C. to 500° C. for 1-10 hours, and at a second temperature of 1,500° C.-2,850° C. for 0.5-5 hours. With these heat treatments, also under a compressive stress, the GO films were transformed into graphene foam, which makes a good CDI electrode.

### Example 7: Plastic Bead Template-Assisted Formation of Reduced Graphene Oxide Foams

A hard template-directed ordered assembly for a macro-porous bubbled graphene film (MGF) was prepared. Mono-disperse poly methyl methacrylate (PMMA) latex spheres were used as the hard templates. The GO liquid crystal prepared in Example 5 was mixed with a PMMA spheres suspension. Subsequent vacuum filtration was then conducted to prepare the assembly of PMMA spheres and GO sheets, with GO sheets wrapped around the PMMA beads. A composite film was peeled off from the filter, air dried and calcinated at 800° C. to remove the PMMA template and thermally reduce GO into RGO simultaneously. The grey free-standing PMMA/GO film turned black after calcination, while the graphene film remained porous.

### Example 8: Production of Boron-Doped Graphene Oxide for ECD Electrode Applications

To produce boron-doped graphene oxide, one can start with a graphene oxide (GO) solution and add a boron source, like boric acid (H₃BO₃), then use a hydrothermal method to incorporate the boron atoms into the graphene lattice, essentially “doping” the GO with boron; this process is usually carried out by mixing the GO suspension with boric acid and heating it in a sealed autoclave at elevated temperatures for a specific duration.

One can synthesize GO using the Hummers method, which involves oxidizing graphite flakes with a strong acid mixture and potassium permanganate. After washing the produced GO sheets in deionized water multiple times, one can disperse the GO in water and add a calculated amount of boric acid to the solution. The GO-boric acid mixture is then transferred to a Teflon-lined autoclave and heat it at a high temperature (typically around 150° C.-250° C.) for several hours. After the hydrothermal process, the boron-doped graphene oxide (B-GO) can be collected by centrifugation, washed thoroughly with water to remove any residual chemicals, and then dried at a suitable temperature.

### Example 9: Preparation of Graphene Foams from Graphene Fluoride

Several processes have been used by us to produce GF, but only one process is herein described as an example. In a typical procedure, highly exfoliated graphite (HEG) was prepared from intercalated compound C₂F·xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, ethanol, 1-propanol, 2-propanol, 1-butanol, tert-butanol, isoamyl alcohol) and subjected to an ultrasound treatment (280 W) for 30 min, leading to the formation of homogeneous yellowish dispersions. Five minutes of sonication was enough to obtain a relatively homogenous dispersion, but longer sonication times ensured better stability. Upon casting on a glass surface with the solvent removed, the dispersion became a brownish film formed on the glass surface. When GF films were heat-treated, fluorine was released as gases that helped to generate pores in the film. In some samples, a physical blowing agent (N₂ gas) was injected into the wet GF film while being cast. These samples exhibit much higher pore volumes or lower foam densities.

### Example 10: Preparation of Graphene Foams from Nitrogenataed Graphene

Graphene oxide (GO), synthesized in Example 4, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene: urea mass ratios of 1:0.5, 1:1 and 1:2 are designated as NGO-1, NGO-2 and NGO-3 respectively and the nitrogen contents of these samples were 14.7, 18.2 and 17.5 wt % respectively as found by elemental analysis. These nitrogenataed graphene sheets remain dispersible in water. The resulting suspensions were then cast, dried, and heat-treated initially at 200-350° C. as a first heat treatment temperature and subsequently treated at a second temperature of 1,500° C. The resulting nitrogenated graphene foams exhibit physical densities from 0.45 to 1.28 g/cm³. Typical nitrogen contents of the foams are from 0.01% (HTT=1,500° C.) to 5.3% (HTT=350° C.), depending upon the final heat treatment temperature involved.

### Example 11: Electrochemical Oxidation of Per- and Polyfluoroalkyl Substances in Chloride-Containing Water on Fluorinated Graphene/Ti₄O₇ Anodes

Electrochemical oxidation using an electrochemical disinfection cell (EDC) has been shown effective in degrading per- and polyfluoroalkyl substances (PFASs) in water, but concurrent formation of chlorate and perchlorate in the presence of chloride is of concern due to their toxicity. This study examined ECD treatment of three representative PFASs, perfluorooctane sulfonate (PFOS), perfluorooctanoic acid (PFOA) and 6:2 fluorotelomer sulfonate (6:2 FTS), in chloride-containing solutions on Ti₄O₇-loaded graphene fluoride layers in an ECD cell.

Magnéli phase Ti₄O₇ powder was produced by heating titanium oxide nano powder at 950° C. and subsequently reduced under a hydrogen flow. The Magnéli phase Ti₄O₇ powder produced was mixed with graphene fluoride (GF, prepared in Example 9), along with polyacrylamide/polyvinyl alcohol, were dissolved in methanol to form a slurry. The slurry was cast over a glass substrate and, upon removal of methanol, a layer of polymer-bonded composite was obtained with a Ti₄O₇/GF/polymer weight ratio of 65/15/20. The composite layer was subjected to a heat treatment (250° C. for 1 h and then 500° C. for 2 hours) to convert the polymer into amorphous carbon that serve to bond the Ti₄O₇ particles and GF sheets together to form a porous anode structure intended for use in an ECD cell.

### Example 12: Preparation of Prussian Blue Analogues (PBA) for CDI Applications

Prussian Blue Analogues (PBAs) were synthesized using the co-precipitation method. A solution containing ferrocyanide ligands was mixed with a solution of metal salts under constant stirring. To control the crystallization process and prevent uncontrolled morphology formation, sodium citrate was added as a chelating agent. The reaction mixture was maintained at room temperature for 12 hours, allowing the formation of well-defined PBA nanocubes. The obtained PBAs were collected by centrifugation, washed multiple times with deionized water, and vacuum dried. The final product exhibited a cubic crystalline structure, as confirmed by X-ray diffraction (XRD) analysis. To enhance electrochemical performance for capacitive deionization (CDI), the synthesized PBAs were incorporated into a composite electrode by mixing with graphene sheets in a 1:1 mass ratio. The electrode slurry was prepared by dispersing the mixture in a binder solution, followed by casting onto a conductive substrate. The resulting electrodes were dried at 100° C. and then subjected to heat treatment at 300° C. to improve structural stability.

The synthesized Prussian Blue Analogues showed excellent ion adsorption capacity due to their open-framework structure, facilitating rapid ion transport. When used in a CDI system, the PBA-based electrodes demonstrated a high salt removal capacity and good cycling stability under optimized operational conditions.

1. A method of producing clean water from contaminated or salt water, said method comprising integrating at least a capacitive deionization (CDI) cell and at least an electrochemical or electro-catalytic disinfection (ECD) cell to create a water purification system, wherein each CDI cell or ECD cell has two electrodes, an anode and a cathode, that are supplied with a voltage or electrical potential and current over the two electrodes, and at least one of the CDI and ECD cells comprises an electrode comprising graphene, MXene, a redox-active species or Faradaic functional group, a PFAS-degrading or PFAS-destructing group, an electro-catalyst, or a combination thereof, where PFAS refers to per- and polyfluoroalkyl substances, and at least one CDI cell and at least one ECD cell are connected in series in such a manner that contaminated or salt water enters from a first end of the system, passes through an ECD and then a CDI cell or through a CDI and then an ECD cell, and finally exits from a second end to produce clean water.

2. The method of claim 1, wherein the CDI cell comprises a symmetric CDI or an asymmetric CDI, wherein the symmetric CDI is selected from a flow-through CDI, an osmosis CDI, a desalination battery, a flow-electrode CDI, or a suspension-electrode CDI and wherein the asymmetric CDI is selected from a flow-through MCDI, an ion-selective flow-through CDI, a hybrid CDI, an inverted CDI, a flow-electrode CDI, or an asymmetric flow-electrode CDI.

3. The method of claim 1, wherein said graphene is selected from pristine graphene having substantially no non-carbon element, graphene oxide, reduced graphene oxide, graphene fluoride, graphene chloride, graphene bromide, graphene iodide, hydrogenated graphene, doped graphene, nitrogenated graphene, chemically functionalized graphene, or a combination thereof.

4. The method of claim 3, wherein the doped graphene comprises a dopant supported by or included in a graphene plane and the dopant is selected from B, Al, Ga, In, Sn, N, S, F, P, Sb, Bi, Se, a transition metal, or a combination thereof.

5. The method of claim 1, wherein the water purification system does not contain a diamond in an ECD electrode or CDI electrode.

6. The method of claim 1, wherein said MXene is in a form of nanoparticles or nano-film having a diameter or thickness from approximately 1 nm to 100 nm.

7. The method of claim 1, wherein said redox-active species or Faradaic functional group is selected from the group consisting of transition metal oxides, metal hydroxides, metal sulfides, metal nitrides, conducting polymers, Prussian Blue Analogues (PBA), Prussian White Analogues (PWA), and combinations thereof.

8. The method of claim 7, wherein said conductive polymers are selected from the group consisting of polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, derivatives thereof, copolymers thereof, and combinations thereof.

9. The method of claim 1, wherein said PFAS-degrading or PFAS-destructing group is selected from a transition metal oxide, a mixed transition metal oxide, O-terminated MXene, B/N-doped diamond (BND), Ti/SnO₂-Sb/PbO₂, Magnéli-phase Ti₄O₇, Platinum, iridium oxide (IrO₂), ruthenium oxide, (RuO₂), Ti/SnO₂—Sb—Bi, Ti/SnO₂—Sb, Ti/SnO₂-Sb/PbO₂, Ti/SnO₂-Sb/MnO₂, Ti/SnO₂—Sb—Ce, Ti/SnO₂-Sb/PbO₂—Ce, Ti/SnO₂-Sb₂O₅/PbO₂, Ti/SnO₂—Sb₂O₅/PbO₂—PVDF (0.5-1% wt), Ti/SnO₂—Sb/Yb—PbO₂, Ti/SnO₂—Sb—PbO₂, Ti/SnO₂—Sb—Yb, Ti/SnO₂—Sb/Yb—PbO₂, Ti/SnO₂—Sb₂O₅—Bi₂O₃, Ti/PbO₂, Ti/TiO₂—NTs/PbO₂, Ti/TiO₂-NTs/Ag₂O/PbO₂, boron-doped diamond (BDD), Nb/BDD, Si/BDD, Ti/BDD-BND, nitrogen-doped diamond (NDD), Si/MCD (microcrystalline diamond), Nb/UNCD (ultranano-crystalline diamond), BDD/PbO₂, BDD/SnO₂, BDD/SnO₂—F, Magn\acute{ }eli phase titanium suboxide (TSO), or a combination thereof.

10. The method of claim 1, wherein the electro-catalyst comprises at least one of: a metal, a metal alloy, a metal oxide, a metal salt, a metal hydride, a metal sulfide, a metal phosphide, or a metal-containing compound; wherein the metal is selected from a group of elements consisting of noble metal elements, alkaline and alkaline earth metal elements, transition metal elements, rare earth metal elements, and low melting point metal elements.

11. The method of claim 1, wherein the electro-catalyst is a metal or metal alloy selected from the group consisting of noble metals, alkaline metals, transition metals, rare earth metals, and low melting point metals.

12. The method of claim 1, wherein the water purification system comprises at least two CDI units and two ECD units that form at least two water flow channels assembled in parallel wherein each of the channels comprises at least one ECD unit and at least one CDI unit connected in series.

13. The method of claim 1, further comprising reversing the electric potential (voltage) or lower the voltage to remove captured ions or chemical species from an electrode of a CDI or ECD cell.

14. A method of producing clean water from contaminated or salt water, said method comprising combining at least a capacitive deionization (CDI) cell and at least an electrochemical or electro-catalytic disinfection (ECD) cell to create a water purification system; wherein the system meets at least one of the following conditions: (i) the CDI cell comprises a symmetric CDI or an asymmetric CDI, wherein the symmetric CDI is selected from a flow-through CDI, an osmosis CDI, a desalination battery, a flow-electrode CDI, or a suspension-electrode CDI and wherein the asymmetric CDI is selected from a flow-through MCDI, an ion-selective flow-through CDI, a hybrid CDI, an inverted CDI, a flow-electrode CDI, or an asymmetric flow-electrode CDI; (ii) the system is a miniaturized water purification system that does not comprise a pump to drive a flow of the water stream; (iii) at least one of the CDI and ECD cells comprises an electrode comprising graphene, MXene, a redox-active or Faradaic functional group, a PFAS-degrading or PFAS-destructing group, an electro-catalyst, or a combination thereof, where PFAS refers to per- and polyfluoroalkyl substances; and (iv) the system does not contain a diamond.

15. A method of enhancing the electrochemical oxidation degradation of per- and polyfluoroalkyl substances (PFAS) in water, said method comprising: (a) using a doped graphene electrode in an ECD device, wherein the graphene is doped with at least one dopant selected from the group consisting of nitrogen, boron, fluorine, sulfur, phosphorus, transition metals, metal oxides, graphene quantum dots, single-atom catalysts, dual-dopants, and heterojunctions with other 2D materials; (b) applying an electrical potential to the doped graphene electrode to generate reactive oxygen species (ROS) that degrade PFAS.

16.-20) (canceled)
